(19) United States
(12) Patent Application Publication
(10) Pub. No.: US 2012/0011005 A1
(43) Pub. Date: Jan. 12, 2012

(54) Sharing advertising revenue with user browsing website

(76) Inventor: Miteshkumar Mahendrabhai Bilimoria, Aurora, IL (US)

(21) Appl. No.: 13/135,619

(22) Filed: Jul. 11, 2011

Related U.S. Application Data
(60) Provisional application No. 61/399,467, filed on Jul. 12, 2010.
(60) Provisional application No. 61/400,537, filed on Jul. 29, 2010.

(51) Int. Cl. G06Q 30/00

(52) U.S. Cl. 705/14.73

(57) ABSTRACT

Presented herein is a web browser that users are paid to use. The web browser includes a small window for advertisements. Advertisers are able to pay on a ‘by the user’ basis, because advertisers can know precisely how many users have viewed the advertisement. The publisher can maintain the browser/browser extension and transmit relevant advertisements based on user data and behavior. The publisher can share part of the revenue generated from advertisers with the users. The software/browser extension can help advertisers connect directly with users.

### CLAIM OF PRIORITY

This application claims priority to “Sharing advertising revenue with user browsing website”, Provisional Application for U.S. Patent Ser. No. 61/399,467 , filed Jul. 12, 2010 and “Sharing advertising revenue with user browsing website”, Provisional Application for U.S. Patent Ser. No. 61/400,537 , filed Jul. 29, 2010 each of which are incorporated herein by reference for all purposes in their entirety.

### BACKGROUND OF THE INVENTION

Internet has revolutionized the advertising industry. Advertisers use Internet to market their products and services online. They create online advertising campaigns without having comprehensive knowledge about users they are targeting. Most of time users ignore the displayed advertisements as they may not be relevant. Advertising industry currently does not have any mechanism to directly connect to online users. One more disadvantage to the advertiser is that they cannot target users when users are looking at their competitor's products or services. Users also do not get any monetary incentive to take interest in advertiser's products or services.

This invention will provide a software/browser extension to bridge the current gap between users and advertisers. This software/browser extension will act as publisher between advertisers and users. Users will share information with publisher. Publisher will share this information with advertisers and help them target users. Advertisers will pay publisher for showing their advertisements. Publisher will share revenue collected from advertisers with targeted user. Advertisers will be able improve their estimated return on investment (eROI) by having comprehensive understanding of targeted users. Advertisers will be able to target users looking at their competitors' products or services or website.

### SUMMARY OF INVENTION

Objective of this invention is to provide publishing platform to help connect online advertisers with online users. Other objective of this invention is to share revenue generated by published online ads with targeted users. It will help advertisers to have good knowledge about targeted users and improve eROI.

### BRIEF DESCRIPTION OF DRAWINGS

FIG. 1 is a web page where users will be provided information and medium to get started;

FIG. 2 is a registration form for users and advertisers for website;

FIG. 3 is a example web page about how software will be downloaded;

FIG. 4 is a diagram to show how browser looks after software/browser extension is installed;

FIG. 5 is a dashboard where users can check and withdraw their earnings;

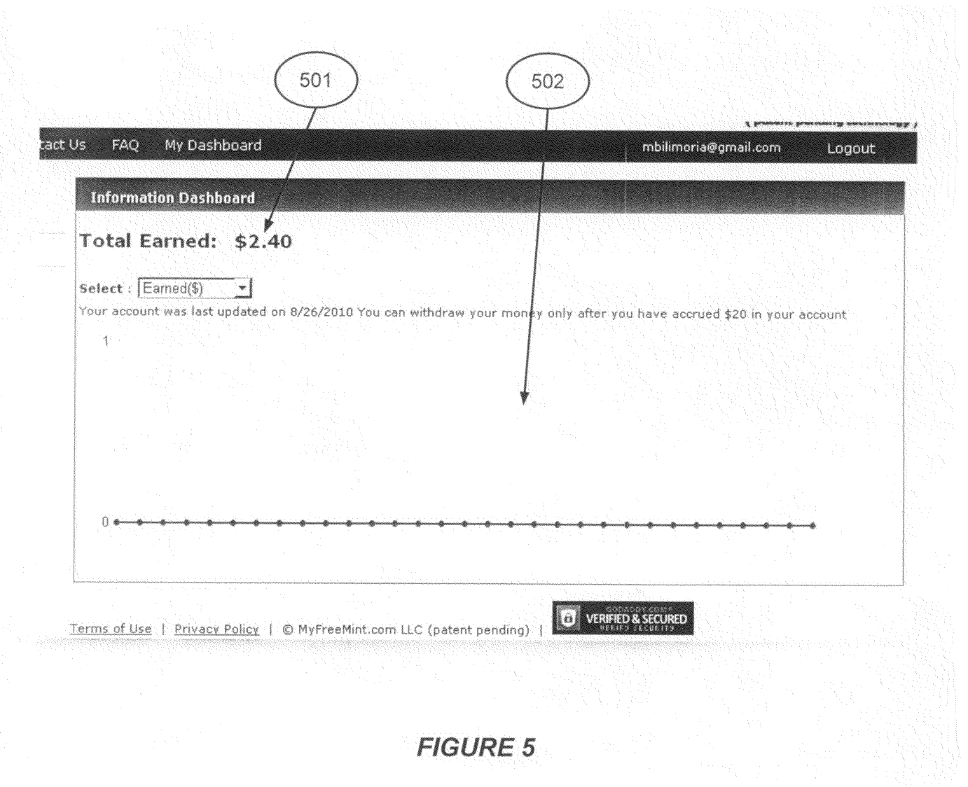

FIG. 6 is a web page to create advertisement for advertisers;

FIG. 7 is a flow diagram for advertisers and users

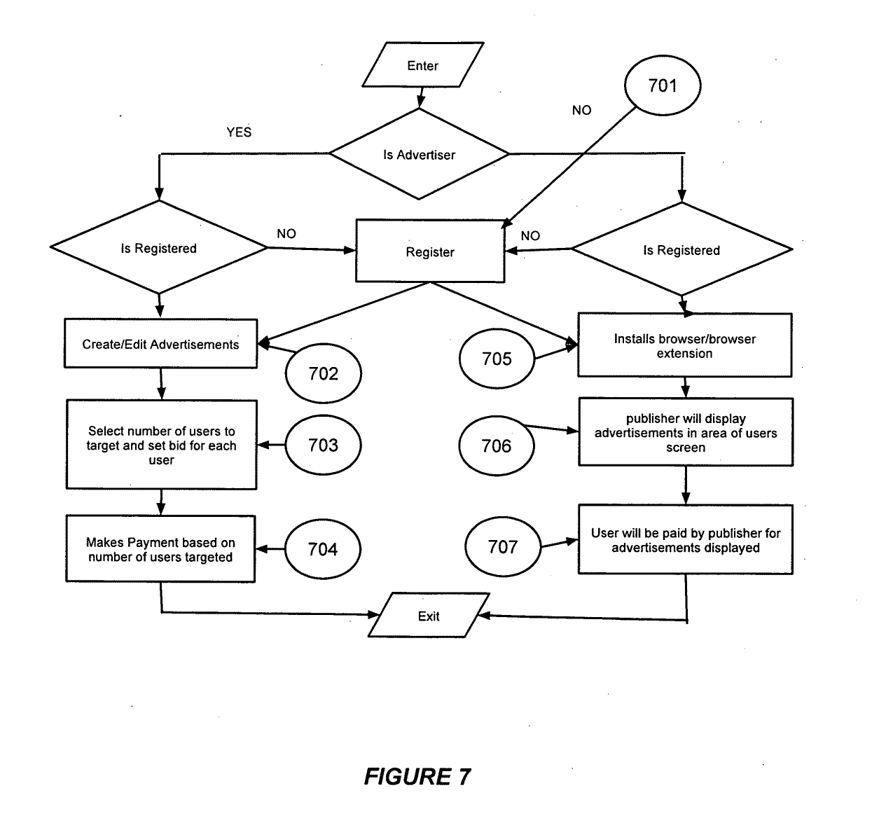

FIG. 8 is a database diagram;

FIG. 9 is an overall system diagram;

FIG. 10 is a flow diagram of how advertisement gets selected; and

FIG. 11 is a block diagram of a computer system.

### DESCRIPTION OF THE INVENTION

World Wide Web has become basic requirement for everybody in the world. Normally people spend more than 13 hours per week of their time browsing through different websites. People go to different websites based on their interest like news, products, video and many more.

Online advertisement has become very effective way of marketing products and services. Advertisers spends large amount of their revenue on online marketing. Advertisers want to target specific demography and interest of people based on their products and services. Targeting specific demography plays vital role in deciding eROI for advertisers. Currently advertisers buy vague user information from third party and try to target them.

Users of world wide web gets targeted with online advertisements of different products and services offered by advertisers. Users try to block these advertisements as if they are not interested. Due to lack to comprehensive knowledge about users, advertisers expose them to irrelevant advertisements. Also, there is no monetary benefit for the user to look at the advertisements.

This invention is a method of connecting users and advertisers, and creating effective connecting medium between them. This method has three embodiments which are discussed below.

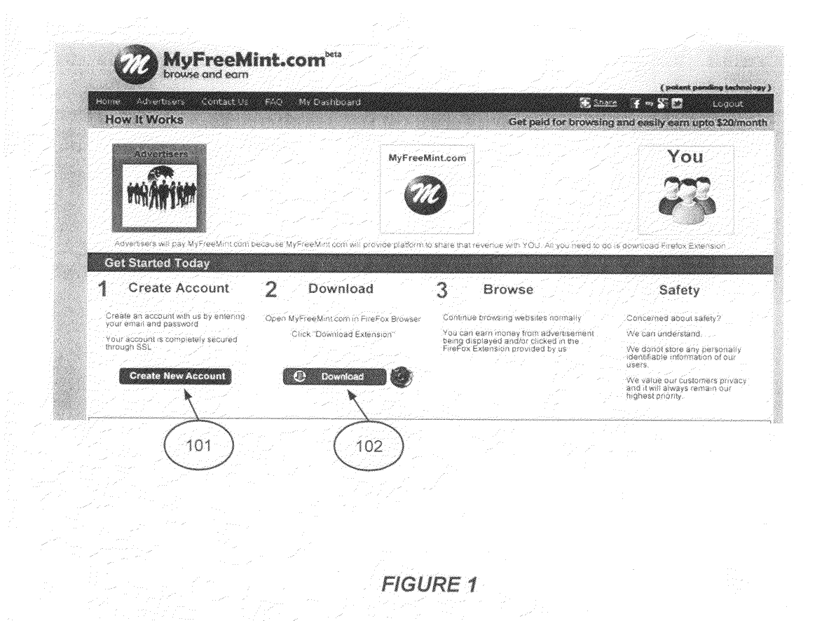

First embodiment is user. In this invention user can set up its own system. Users will be provided with user interface where they can get information about how to get started and this can be seen in FIG. 1. This user interface will guide users about how to earn money by just browsing and actively interacting with advertisers. In FIG. 1 “Create New Account” button/link 101 will take user to create their account and “Download” 102 link/button will take user to download software or browser extension.

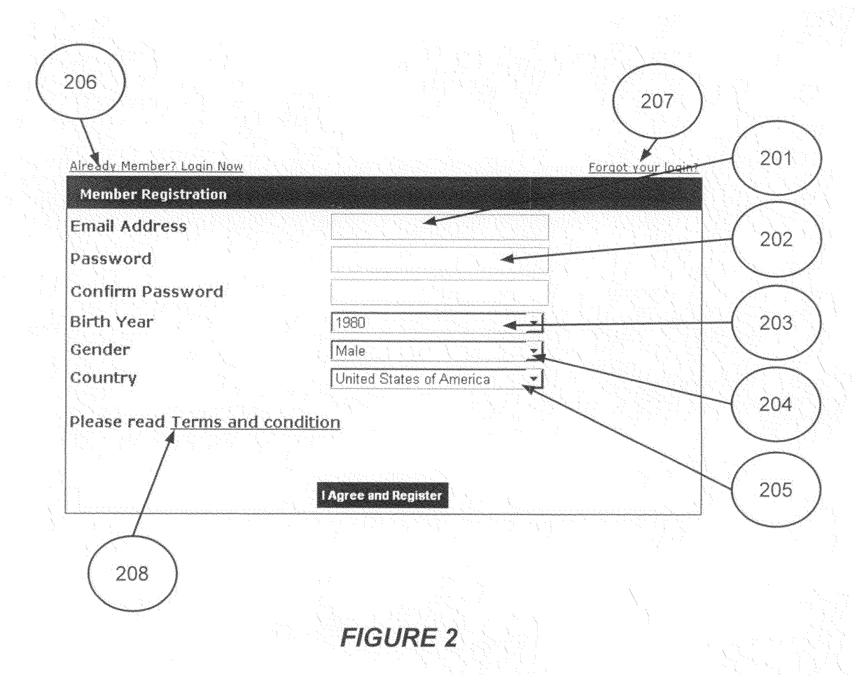

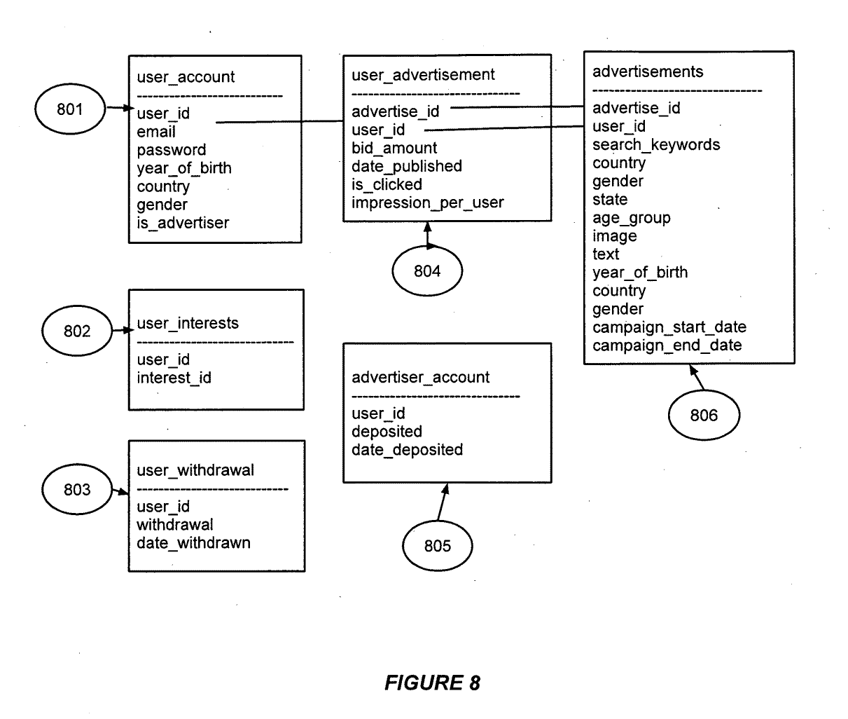

In FIG. 2, user will enter their email address 201, password 202, birth year 203, gender 204 and country 205. Once they click on “I agree and register”, it will insert record into user account database table as shown in FIGS. 8-801. Users can enter more demographic and personal interest information after registration is complete.

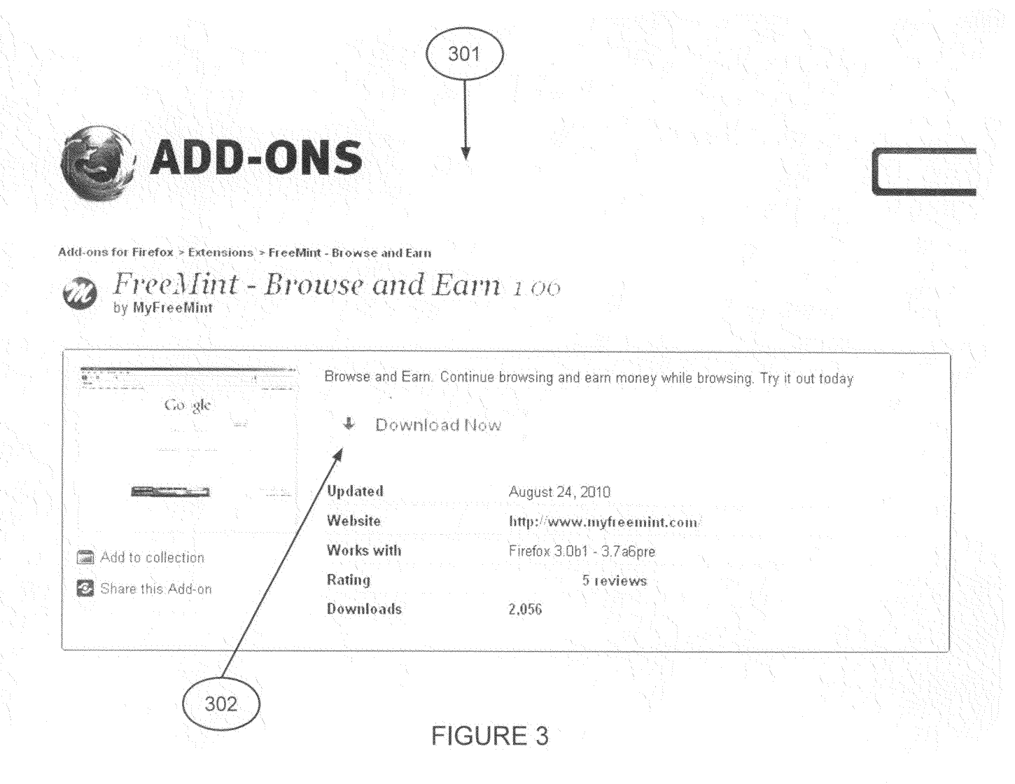

In FIG. 3, clicking on “download now” link 302 will download software or browser extension on user's electronic device. Once software is downloaded, it will guide user to install it.

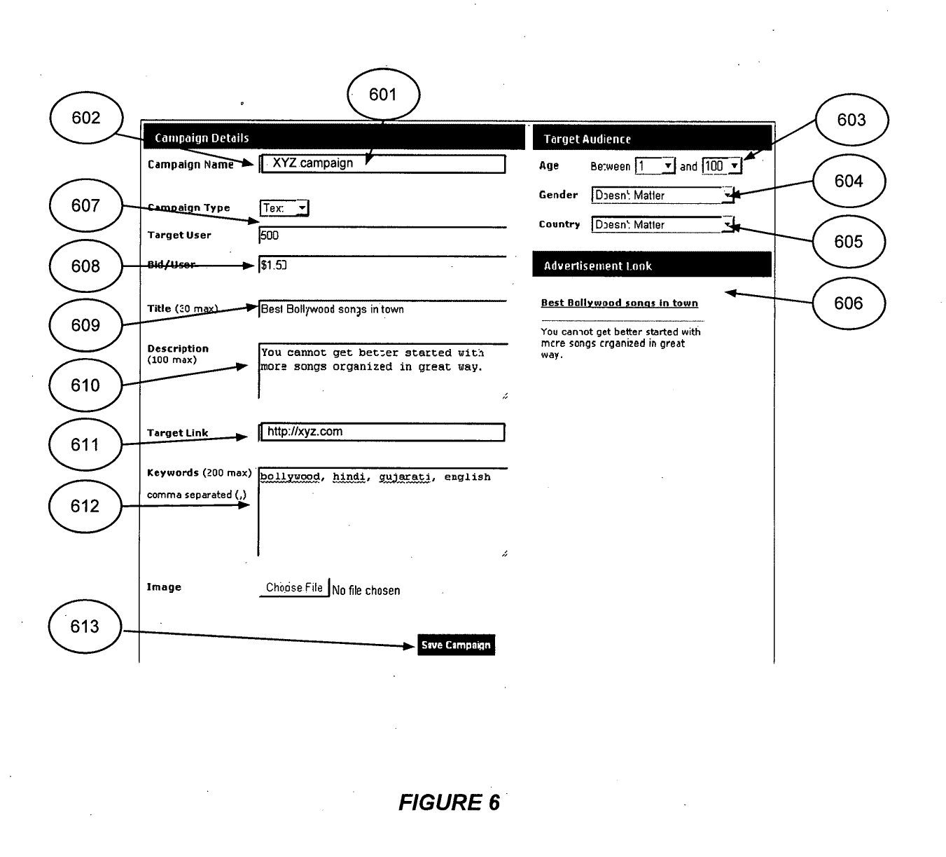

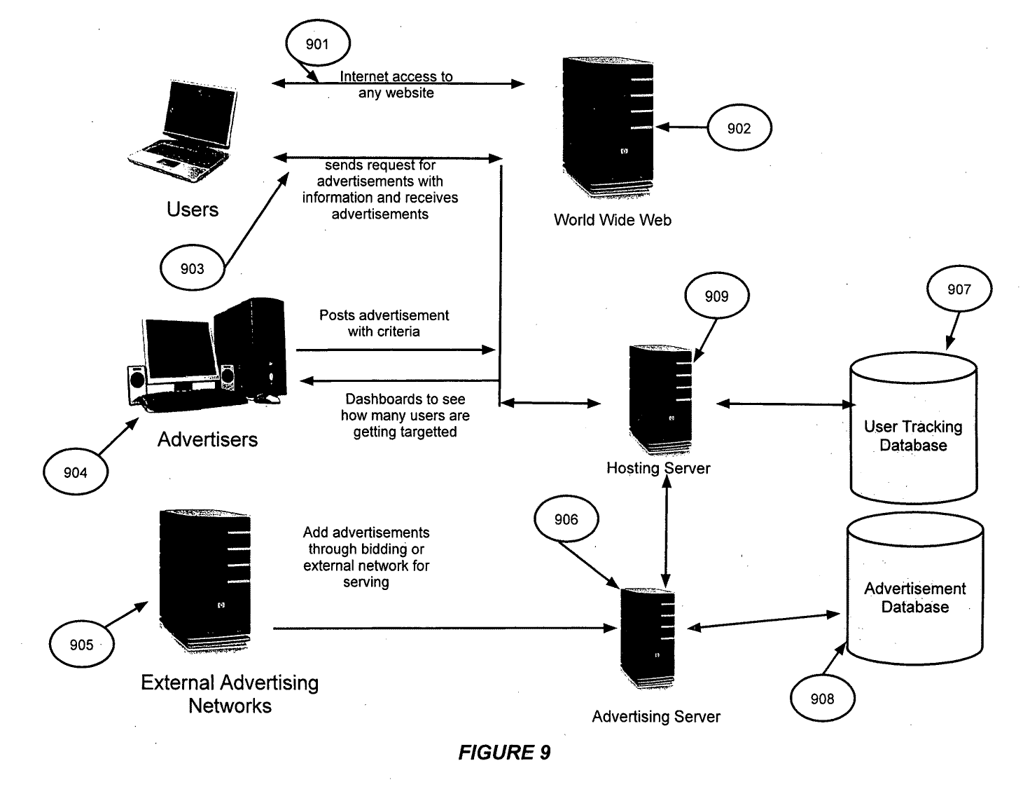

Second embodiment is advertiser. Advertisers will be provided medium to enter their advertisements as shown in FIG. 6. Advertisers will be able to provide campaign name 601, campaign type 602, total number of users to target FIG. 607, Pay per User 608, title 609, description 610, and target link 611 and keywords 612. They can also select which users they want to target based on age 603, gender 604, country 605 and more information provided by users. Once all information is entered, advertisers will click on “Save Campaign” 613 to save campaign information. All information entered above will be inserted in advertisement database FIGS. 9-907 in database table advertisements FIGS. 8-806.

Third embodiment is publisher. Publisher will serve as a mediator between advertisers and users. Publisher will maintain software or browser extension that users will download. Publisher will provide website to allow users to check and withdrawn funds from their account. Publisher will help advertisers to set up their campaign and guide them how to target users. Publisher will also maintain algorithm that will decide which advertisements will be displayed to user.

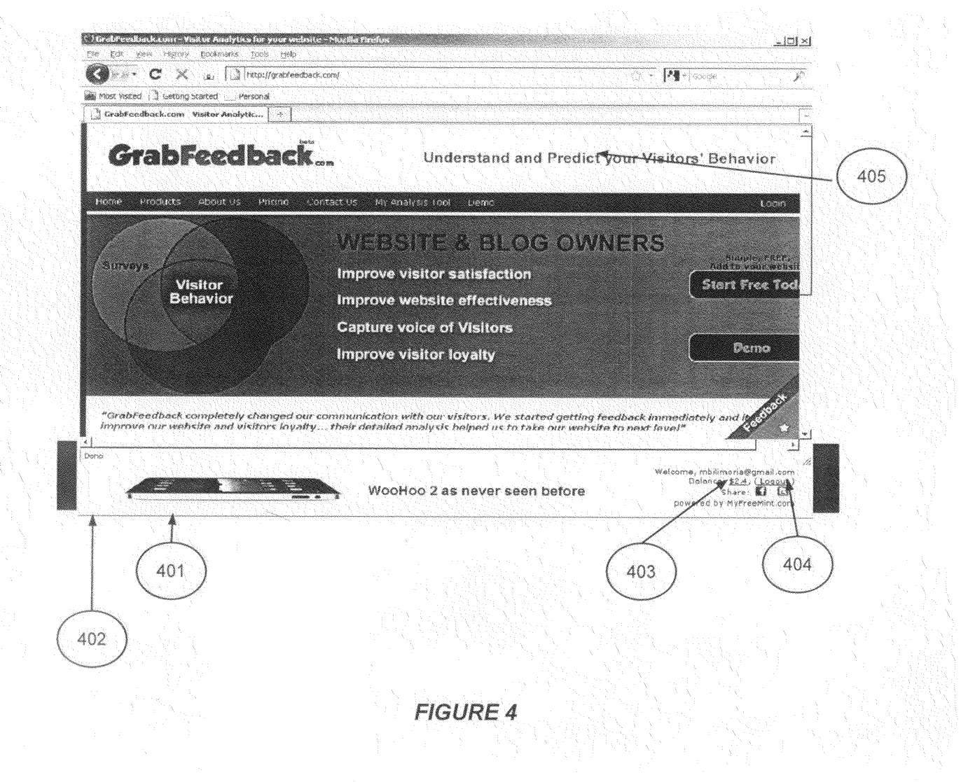

After installation of software or browser extension, users can see different areas on their electronic device. Users will continue browsing different websites, and that website will be displayed in one of these areas FIGS. 4-405 without any modifications. Based on website being browsed and data provided by users, advertisements will be displayed in other advertisement areas FIGS. 4-402. Advertisement area will include advertisement FIGS. 4-401, non-withdrawn amount earned by that user till date FIG. 4-403 and link to logout FIGS. 4-404.

When user starts browsing any website, two requests will be sent to World Wide Web by browser. First request will go to the website they are trying to browse FIGS. 9-901. Request will be loaded into display area FIGS. 4-405, without any modification. After first request is loaded into display area 405, a second request will be sent to publisher FIGS. 9-903 from software or browser extension. This request will include information about first request loaded in 405 received and user who has logged in. Request will be sent through internet to hosting server FIGS. 9-909.

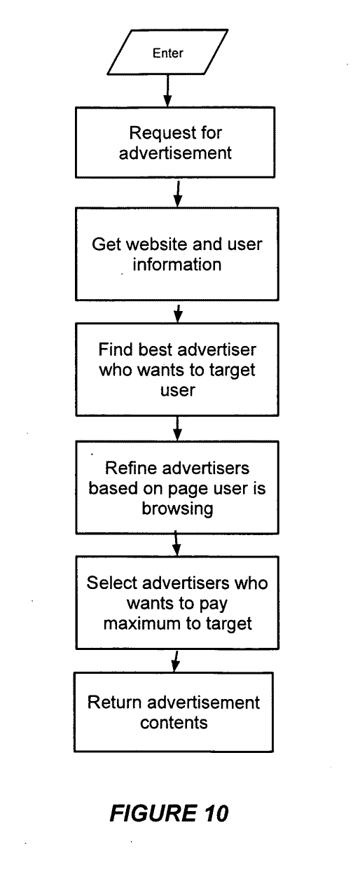

Hosting server 909 will receive request from software or browser extension. Hosting server will contact advertising server 906 and pass on user information and website information which user is browsing. Advertising server will then run advertisement selection algorithm as shown in FIG. 10.

As per FIG. 10, advertising server will first find all advertisers who want to target user browsing the website. From those groups of advertisers, algorithm will select best advertiser based on user interest and demography. Advertisers when adding their campaign enters amount they want to pay per user to target them. Advertiser who pays maximum for that user gets selected. Once advertisement is selected by algorithm, a record is entered into user advertisement data table FIGS. 8-804 in user tracking database FIG. 9-908. Advertiser's account will be charged with bidding amount. Publisher will also credit user's account part of bidding amount. Publisher will provide method for advertisers to bid real time for a user. During advertisement selection process, publisher can also contact external advertising networks or bidding networks FIGS. 9-905.

Once advertisement is selected, advertising server 906 returns that back to hosting server 909 which returns it back to software or browser extension. Software or browser extension will then show that advertisement to the user. Once advertisement is displayed in advertisement display area FIG. 4-402, users can click on that advertisement to view more information about offered products or services. Activities like click and mouse over will be tracked in user tracking database 908 and provided tc advertisers. This connection between advertisement and user will be established for specific interval of time. During this time interval user can be targeted with the same advertisement without any additional cost to advertiser.

Publisher will provide method for users to withdraw money from their account. Users will be induced to provide more information, because more information they provide, more advertisers can target them. Publisher will also have refer-a-friend program for users where publisher will share extra amount if user refers to friends. This extra amount will be deposited in users account only if referred friend successfully joins publisher user network.

Publisher will provide method for advertisers to see activities on their campaign. It will also guide advertisers how to target more users. It will tell advertiser how many users were targeted, what kind of interaction they did with advertisement and what the success rate was.

Advertisers will be induced to use this method because they can increase their estimated return on investment (eROI). Advertisers will also have good knowledge about user and will help them to target easily.

Most companies do not allow any other products or services advertisement on their website. e.g. Apple will not allow Amazon to put advertisement of its product on their website. In this method we can actually show competitors' products or services in advertisement window FIG. 4-402. e.g. If user is looking at iPad on Apple.com, Amazon can advertise their competitive product such as Kindle in advertisement window. This method gives advertisers opportunity which is not possible right now.

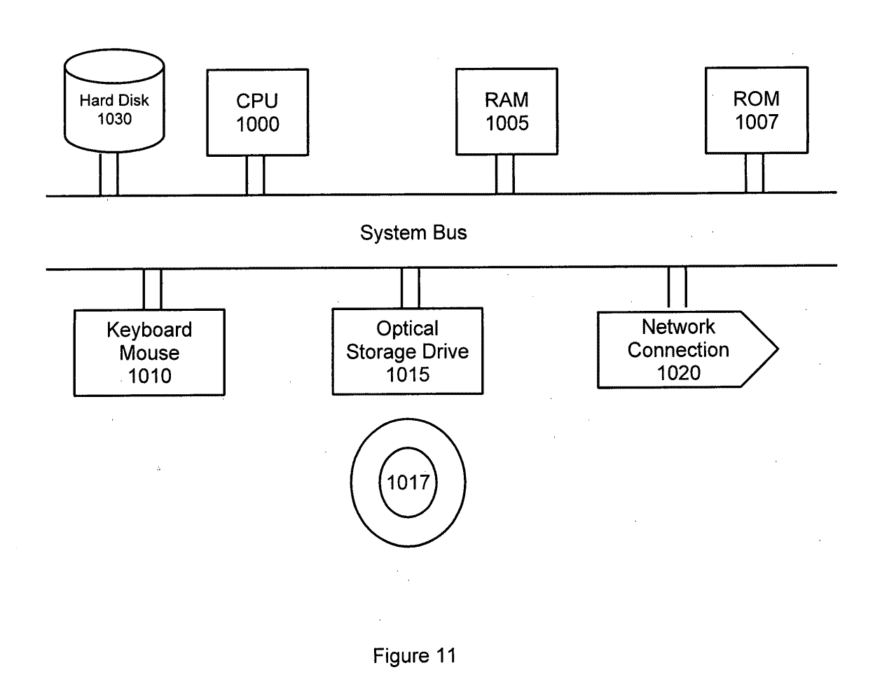

Referring now to FIG. 11, there is illustrated a block diagram of computer system. The computer system comprises a CPU 1000, Random Access Memory (RAM) 1005, Read Only Memory 10010, hard disk 1030, keyboard/mouse 1010, and optical storage drive 1015 for accepting optical storage, such as Compact Disc or DVD 10110, and a network connection 1020. The foregoing care connected by a bus.

The CPU 1000 is configured to executed instructions that are resident in various memories in the computer system, including the hard disc 1030, and optical storage device 10110. The instruction can reside in the foregoing memories, while awaiting execution by the CPU 1000. The instructions can be transferred to the RAM 1005 executed by the CPU 1000.

The network connection(s) 1020 connects the computer to a network, such as the internet comprising other computers. The network connection(s) 1020 can comprise, but is not limited to, either a port connected by a cable, or wireless network connection, such as a (wireless fidelity) Wi-Fi connection, wireless local area network (WLAN), or cellular connection, to a network such as the internet.

One embodiment of the present invention can a plurality of instructions stored in the optical storage 1015, hard disc 1030, RAM 1005 or a combination, thereof. The combination can also include optical storage 1015, hard disc 1030, RAM 1005 of an additional computer connected to the computer via the network connection 1020(s).

It is noted that in certain embodiments of the invention, the computer system 1000 can be hand-held sized and equipped to maintain a phone conversation over network connection 1020.

It is noted that storage of the instructions on the optical storage 1015, hard disc 1030, and RAM 1005 chemically, mechanically, electrically, and/or magnetically transform the optical storage 1015, hard disc 1030, and RAM 1005. In certain embodiments of the present invention, a computer system can be sold pre-loaded with the browser.

The foregoing illustrates exemplary embodiments of the present invention. It is noted, however, modifications and substitutions can be made without departing from the spirit of the invention. Accordingly, the invention is only limited by the following claims and equivalents thereof.

1. A method of web browsing, said method comprising:
providing advertisements on the browser;
tracking usage of the web browser by the user; and
paying the user based on web browser usage

2. The method of claim 1, further comprising receiving money from advertiser for displaying the advertisement.

3. The method of claim 2, wherein paying the user comprises paying the user a portion of the money from the advertiser.

4. The method of claim 1, wherein the advertisement is displayed in separate portion of said browser and is different from the web page viewed by user.

5. The method of claim 1, wherein providing advertisement comprises transmitting the advertisements from a dedicated mode that is different from a web server viewed by user.

6. A non-transitory computer-readable medium storing a plurality of instructions for:
generating a browsing window for displaying web pages selected by a user
establishing a connection with a predetermined advertiser server
generating another window for providing advertisements from the predetermined advertising server;
tracking usage of the browsing window; and
paying the user based on the usage of the browsing window.

7. The non-transitory computer-readable medium of claim 6, wherein the plurality of instructions further comprise instructions for receiving money from advertiser for displaying the advertisement.

8. The non-transitory computer-readable medium of claim 6, wherein paying the user comprises paying the user a portion of the money from the advertiser.

9. The non-transitory computer-readable medium of claim 6, wherein the advertisement is displayed in separate portion of said browser and is different from the web page viewed by user.

10. The non-transitory computer-readable medium of claim 6, wherein providing advertisement comprises transmitting the advertisements from a dedicated mode that is different from a web server viewed by user.

11. A computer system, said computer system comprising:
a processor;
a screen connected to the processor;
a port connected to the processor, said port configured to establish a connection to a network;
a non-transitory computer-readable medium storing a plurality of instructions, connected to the processor, the plurality of instructions executable by the processor for:
generating a browsing window on the screen for displaying web pages selected by a user and received over the port;
establishing a connection with a predetermined advertiser server over the port;
generating another window on the screen for providing advertisements from the predetermined advertising server;
tracking usage of the browsing window; and
paying the user based on the usage of the browsing window.

12. The computer system of claim 11, wherein the plurality of instructions further comprise instructions for receiving money from advertiser for displaying the advertisement.

13. The computer system of claim 11, wherein paying the user comprises paying the user a portion of the money from the advertiser.

14. The computer system of claim 11, wherein the advertisement is displayed in seperate portion of said browser and is different from the web page viewed by user.

15. The computer system of claim 11, wherein providing advertisement comprises transmitting the advertisements from a dedicated mode that is different from a web server viewed by user.
